(19) United States
(12) Patent Application Publication
(10) Pub. No.: US 2023/0358775 A1
(43) Pub. Date: Nov. 9, 2023

(54) IMPROVEMENTS IN OR RELATING TO ASSAY TIMING

(71) Applicant: Vidya Holdings Ltd, London (GB)

(72) Inventors: Stefan Leo Van Workum, London (GB); Vladimir Alexander Turek, London (GB); Marko Dorrestijn, London (GB); David R. Klug, London (GB)

(73) Assignee: Vidya Holdings Ltd, London (GB)

(21) Appl. No.: 17/786,435

(22) PCT Filed: Dec. 18, 2020
(86) PCT No.: PCT/GB2020/053281

§ 371 Date: Jun. 16, 2022

(30) Foreign Application Priority Data
Dec. 19, 2019 (GB) 1918889.5

(51) Int. Cl. G01N 35/02; G01N 35/00; B01L 3/00

(52) U.S. Cl. CPC G01N 35/025; G01N 35/0092; G01N 35/00732; B01L 3/502; G01N 2035/0096; G01N 2035/00356; G01N 2035/00306; B01L 2300/023; B01L 2200/147; B01L 2200/04; B01L 2200/16

(57) ABSTRACT

A storage and incubation device is provided. The device is configured to accommodate a plurality of assay chips, each assay chip including a unique identifier. The device comprises: a plurality of berths each sized to accommodate an assay chip; a communication module configured to receive information about the identifier of each assay chip; a clock timer configured to monitor the timing of the assay within each assay chip; a completion module to manage each assay chip when the assay is complete.

The present invention relates to improvements in or relating to assay timing and, in particular, to assay timing in a domestic application.

Traditionally, biological assays on relatively large samples, in the range of one to several millilitres, are conducted in strictly controlled environments by skilled operatives such as laboratory technicians or, alternatively, by using an automated computer controlled system, such as an automated pipetting robot. The most common bodily fluid tested is blood because the relevant biomarkers are present at relatively easily detectable levels and the strictly controlled environment and skilled operatives are compatible with the biohazardous aspect of dealing with blood samples.

Moving from a laboratory setting to a domestic application raises a number of problems including that extracting, processing and disposing of blood samples represents a biohazard in a domestic setting. In this context, the term domestic setting or application is intended to encompass any non-clinical environment which is relatively uncontrolled and the operative is unskilled such as the home, workplace, pharmacy or doctor's surgery. The term domestic setting is also intended to encompass retail, vending and convenience scenarios.

There are some blood tests that are performed in the point of care environment. These typically use a small volume of blood such as a finger prick test. However, this procedure is intrusive and painful and therefore can have compliance issues in any circumstance where the test could be deemed non-essential by the user.

Integrated assays, that is, assay chips that include all of the reagents and microfluidics to be entirely self-contained, have been developed for use in the domestic environment. These assays obviate the need for the addition of further reagents and also pumping or washing steps, through a careful selection of detection reagents and capture components provided within the assay chip and through the provision of microfluidic configurations that control the flow of a liquid sample provided through the assay chip to combine with detection reagents and capture components under optimum conditions.

However, a key issue around accurate quantitative integrated assays in the domestic or point of care setting relates to the timing of the assay. The signal strength of a diffusion-based assay increase with time as more analyte is captured. Although the assay will eventually reach an equilibrium condition where the assay has effectively been completed, the time period required for this is often incompatible with a point of care application where speed of results is paramount. Therefore, it is important, in this context, to be able to identify positively the time at which the assay commenced and to share this information so that the assay can be managed effectively.

The apparatus commonly used in the laboratory setting are designed to manage high throughput of assay chips and to provide stacking, sorting and a controlled environment in which the assay chips can be incubated. Such apparatus often includes conveyor belts, rotary shelves and transfer station where chips are selected and passed on to a subsequent process or station. These systems often include a crane-like device or a multi-axis robotic arm with grippers or other functional head. These systems need to be operated by a skilled operative and would be entirely out of place in a domestic setting as they would be too large and too complex and their complex operating parameters would likely not be met in the domestic context.

There is therefore a need to provide timing and stacking solutions that allow assays to be accurately timed and fed to a reader in a timely fashion. A stacking solution is required that enables parallel processing of the assay chips because serial processing of assay chips is not compatible with the home, workplace or retail environments that are the targets for this innovation.

It is against this background that the invention has arisen.

According to the present invention there is provided a storage and incubation device configured to accommodate a plurality of assay chips, each assay chip including a unique identifier, the device comprising: a plurality of berths each sized to accommodate an assay chip; a communication module configured to receive information about the identifier of each assay chip; a clock timer configured to monitor the timing of the assay within each assay chip; a completion module to manage each assay chip when the assay is complete.

The storage and incubation device is required in scenarios where it is not viable for incubation to take place in the reader because the reader is required to undertake readings at a greater rate than they can be incubated. The device therefore provides a plurality of berths in which chips can be stored whilst the assays are underway.

The berths may be configured to accommodate an assay chip that is standardised in terms of its outer envelope and dimensions. However, it may be advantageous for the berths to be able to accommodate a number of differently sized assay chips. In this way the shape and configuration of the chip can provide easy identification for the user as to which biomarkers and therefore which intended end user a specific chip is tailored. For example, a child's assay chip may be a smaller size and a different shape from an adult's chip so that each user can identify their own chips with ease.

The device is provided with a communication module that is configured to receive information about the identifier provided on the assay chip. The communication module may be a scanner which may read the data provided on the assay chip directly in the form of the identifier or unique identifier. Alternatively, the communication module may be configured to obtain this information indirectly from another part of the system, such as from the reader or from a centralised location wherein data is aggregated.

The identifier may be a unique identifier or it may be a batched identifier or merely a type identifier. In some embodiments the identifier may be blank. In this scenario the communication module may be configured to draw certain conclusions from the lack of a positive identifier at an expected location. For example, if positive identification of the assay type, batch or unique ID is not found, then the storage and incubation device may be configured to treat the assay chip according to a default protocol such as assuming that no timing is present on the chip and that the storage and incubation device must therefore undertake the timing; assuming that the assay has not commenced and therefore the timing of the assay should commence from T=0 when the assay chip is introduced to the incubation and storage device and assuming that the assay should run for two hours before ejecting the assay chip using the completion module, into the reader.

The assay chip may be provided with a batch identifier. This is not a unique identifier but it provides information about the assay provided on the chip and the time for which it should be incubated. In some embodiments, it also provides information about the batch of reagent present in the assay.

Each assay chip may have a unique identifier and, in embodiments where a unique identifier is provided, it needs to be read and acted upon by the system as a whole. The unique identifier may be read by a scanner in the storage and incubation device or it may be read in another part of the system and the data may be transmitted to the storage and incubation device via the communication module of the storage and incubation device. The unique identifier may fixed and take the form of a barcode or QR code. Alternatively, the unique identifier may be editable and include some form of memory enabling this data storage facility. The data storage may be in any suitable form of memory, either volatile or non-volatile, including but not limited to RAM, SRAM, ROM, EEPROM or Flash memory. For example, the unique identifier may be an RFID tag.

Associated with the unique identifier will be, at least, information relating to the incubation time required by the chip. There may also be quality assurance information, effectively confirming that the single use chip has not been used previously. There may also be identity data assigning the chip to its intended end user. This enables data pertaining to the user to be aggregated over time, by associating each data point to the user. This data is aggregated at a centralised location, such as the cloud, and each new reading assigned to that user is added to that user's data. In this way, trends in an individual's levels of certain biomarkers can be tracked over time, establishing normal patterns that are specific to the individual and therefore being able to identify data points that sit outside the individual's normal levels. Within the context of the storage and incubation device, the identity data assigning the chip to its intended end user also facilitates the system associating multiple, sequential reads with the same chip, thereby providing multiple different time point during assays being sensed and the data collected as associated with the unique identifier and thereby the intended end user of the chip.

The clock timer is configured to time the assay. It may time the entire assay in embodiments where the initiation of the assay is effected by the reader. Alternatively, it may synchronise with a timing device on the assay chip itself which may have commenced timing the assay prior to the chip being inserted into the device.

The completion module may take various different forms but all of them attend to what occurs with the chip once the assay is complete. The completion module may be configured to ‘freeze’ or ‘quench’ the assay by flushing through either more saliva or liquid, or, conversely by drying it. Each of these “forced completion” modes would then allow the chip to be stored in this state for additional time before the results are obtained from the chip. In some embodiments, the completion module may be configured to leave the assay chips within the berths, but confirm, for example via the cloud, that no further action is required in relation to one or more of the assay chips. The user could then be permitted or facilitated to remove the chip at their convenience.

The completion module may include a mechanism to eject the assay chip from the device. The assay chip may be ejected from the device for the attention of the user or it may be ejected from the device directly into the reader. The reader will then be able to interrogate the chip to obtain the results of the assay and to further process the information obtained. There are several possible embodiments of the completion module that is configured to transfer the chips from the storage and incubation device into the reader. This transfer may be implemented by a plurality of linear actuators, which may be pneumatic, electric or hydraulic. The linear actuators may be combined to form a conveyor. Alternatively, or additionally, there may be other forces deployed to implement the transfer such as magnetic forces or compressed air.

In some embodiments, completion of the assay may be after a predetermined time which enables the assay to reach an end state. In other embodiments, completion of the assay can refer to the number of readings which have been taken from the chip. For example the assay may be determined to be complete after at least one reading has been taken from the assay chip, or the assay could be determined to be complete after two or more readings have been taken from the assay chip. The communication module may be further configured to obtain clock data from the assay chip and provide this clock data to the clock timer. This is applicable in embodiments where the user initiates the assay by closing the assay chip and therefore the assay has already commenced by the time the assay chip is introduced into the device. The clock timer therefore synchronises with the data obtained from the chip and times the remaining part of the assay.

The device may further comprise a loading slot sized to accommodate an assay chip. The provision of a loading slot or cubby for the assay chip makes it easy for the user to interface with the device by providing positive assurance of the correct placing of the assay chip. In some embodiments a single loading slot is provided with different berths being indexed into position behind the loading slot. However, in some embodiments, there may be more than one loading slot. In particular, there may be one loading slot provided for each berth so that the user is guided to introduce the assay chip into the relevant berth directly through a dedicated loading slot.

In some embodiments, the loading slot is provided with a cover. The cover keeps dirt and dust and, in some embodiments, light out of the berth into which the assay chip is loaded through the loading slot.

The device may further comprise at least one sensor for monitoring the conditions with the device. The sensor may be a temperature sensor or a humidity sensor. In some embodiments both temperature and humidity sensors may be provided.

The temperature will affect the rate at which the assay proceeds and therefore it is useful to monitor the temperature within the device as it may affect the time required to complete the assay. The humidity can also affect the assay with elevated humidity introducing risk of interference with the capture components and detection reagents and putting in doubt the results.

The device may further comprise a temperature control device. Depending on the intended deployment of the device, the temperature controller may include a heater and/or a refrigeration unit which can be deployed to maintain the interior of the device within an acceptable temperature range.

The device may further comprise humidity control device.

The device may further comprise a protrusion that mechanically urges the chip into a configuration whereby the assay is initiated. The protrusion can be elongate or it may take the form of a narrowing of the passage through which the assay chip passes such that pressure is applied across the surface of the chip to ensure the closure occurs without raising the pressure excessively in any one location.

The device may further comprise a mechanism for reordering the assay chips. The mechanism enables the reordering of the chips so that the chips can be ejected from the device in the order in which the assays are completed. As different chips may be operating different assays that require different incubation times then the order of introduction of the chips to the device may differ from the order in which the chips are ready to be introduced to the reader and therefore reordering may be required. Some assays may be complete within an hour whereas others may require two hours, four hours, eight hours, twelve hours or even up to 24 hours to complete.

The mechanism may also enable chips to be sent from the reader back to the storage and incubation device. This enables a further reading to be taken from a single chip. This allows the time dependency of the assay to be better managed, for example taking a first reading during the assay and then a second reading once the assay has completed and the value has plateaued. This procedure may be used for all assay chips or just those that fulfil certain criteria on first reading. Therefore, the mechanism facilitates sequential readings from the same chip without requiring user input or supervision, facilitating a high-throughput of assay chips.

The mechanism being configured to bring a chip to the reader on multiple occasions also enables readings for multiple different markers which proceed at different speeds to be read at a time optimised for that marker.

The storage and incubation device described above may be incorporated into a system for managing incubation and reading of assay chips, the system further comprising a reader.

The reader may be provided in a light tight case. The reader may include a communication module that enables transfer of data from the storage and incubation device. In embodiments in which the reader and the storage and incubation devices are provided in separate housings, a communication module may be provided in the reader and also in the storage and incubation device. These communication modules may communicate directly with one another and also communicate to the cloud and therefore indirectly between the subsections of the system.

The reading of assay chips by the reader may be an optical measurement, such as light scattering or fluorescence measurements. The excitation light may be provided in the form of total internal reflection (TIR). The reader may be a device configured to extract data from the chip. For example, the reader may be able to extract data associated with biomarkers which can be used to track the state of health or wellbeing or an individual and/or identify certain diseases or symptoms from the saliva sample.

The communication between the storage device and the reader may be direct or indirect. In particular, the communication may be facilitated via the cloud, thereby also providing data to the cloud for incorporation in the user's profile. This enables the longitudinality of the system to be achieved in that the same test can be performed by the same user on multiple occasions, providing a personal profile that is unique to that user. This allows a much smaller percentage variation to be permissible than within the general population.

The system may further comprise a used chip collection zone. The chip collection zone can be just a zone to locate the chip so that the user can dispose of it with other waste products. Alternatively, it may be a dedicated waste bin configured to contain all of the chips ejected by the reader. In a further embodiment, the chip collection zone can be a storage device that stores the ejected chips securely for disposal via biohazard waste removal such that the user is not required to come into contact with the ejected chips.

The used chip collection zone may have a sensor to indicate that it needs to be emptied. In order to minimise environmental impact, it is preferable that the chips can be returned for recommissioning or recycling. Once full then this may compromise the performance of the device as there is no room for additional chips to be ejected.

The sensor may be a weight sensor or a light trap. The light trap is configured to identify that used chips are occupying more than a predetermined threshold height within the used chip collection zone. The weight sensor will identify the total weight of used chips. When a predetermined threshold value is exceeded, the user will be notified that the chip collection zone needs to be emptied.

In some embodiments, the chip collection zone is assumed to be full after a predetermined number of chips have been introduced into that zone and therefore the sensor just senses the number of chips that have been ejected from the device.

In some embodiments, the storage and incubation device and the reader are contained within a common housing.

In some embodiments, there are a number of berths is a substantially circular configuration around a central axis. The berths can be located on a carousel which can be rotated axially so that each berth is positioned adjacent to the loading slot in order to receive a chip. The rotational motion of the carousel is preferably confined to a number of indexed positions, each of which corresponds to one of the berths being aligned with the loading slot. At one of the other locations on the carousel, the reader is provided. Each of the chips can be brought into the reader position. The carousel can be rotated through each of the indexed positions until the chosen chip is positioned in the reader. This rotational motion of the carousel means that the chips do not have to be reordered if they are introduced in an order that is different from the order in which they need to be read. Inside of having to reorder the chips, the carousel can simply be rotated to address the correct chip at the relevant time.

In some embodiments, the cleanliness of the berths can be maintained by irradiating each berth with UV light after assay chip ejection to remove any biohazardous material from the berth. This has to potential to prevent any contamination between chips.

In some embodiments, the rotational motion of the carousel facilitates the taking of sequential readings from the same chip by enabling the chips to be cycled through, and negating the need for user input or supervision. The carousel therefore smooths the flow of chips by enabling the rapidly sequential introduction of multiple chips into the device, addressing the timing and reading of the assays without requiring user input.

The liquid sample may be any bodily fluid including, but not limited to blood, serum, plasma, semen or saliva. Different bodily fluids include varying levels of different biomarkers. Blood typically has relatively high concentrations of biomarkers of interest and therefore, in the laboratory setting, where biohazardous nature of processing and disposing of blood samples is not an issue there is a strong preference for using blood as the liquid sample because the biomarkers are present in relatively high concentrations and are therefore easily detectable.

However, in moving to the domestic or point of care setting, or any other relatively uncontrolled environment in which the operative is unskilled, blood processing becomes problematic. Furthermore, it is known that biomarkers tend to be present in much lower concentrations in saliva than they are in blood. There is therefore a considerable barrier to overcome in order to move from conventional blood testing to the use of saliva as the fluid sample. In order to detect biomarkers that are present in low concentrations, it is necessary to optimise the detectors to detect such low concentrations.

Providing a saliva sample is a simple, non-intrusive procedure. As a result, users are typically more willing to provide a saliva sample than, for example, a blood sample. Furthermore, this increases the frequency with which a user can be expected to provide a sample. By providing frequent samples, a personalised base line can be established for each user allowing a personal profile to be established and therefore feedback can be provided if level fall outside the expected levels for that individual. These can be a much tighter set of parameters than for the population as a whole.

The use of saliva as the sample fluid is also appropriate to a wider range of settings, for example the home or even the workplace. In some embodiments, all employees may be requested to provide a daily sample in order to look for pre-symptomatic flu. This can enable an employee to be sent home before symptoms develop, potentially reducing the number of colleagues infected by that individual and also potentially lessening the symptoms of the infected individual as a result of taking time off in advance of symptoms presenting.

The design of the assay cartridge or assay chip for use in this wider range of settings has to be appropriate to the setting. As a consumable item, for use by an end user, it has to be simple and intuitive to operate. It is designed to take a single sample from a user via a sample reception device included in the assay chip and then to store that sample and perform an immunoassay on that sample. As such, it entirely removes the risk of cross contamination as only one sample is provided in each assay cartridge or chip. The results of that assay can then be read, optically, by a reader into which the chip or cartridge is inserted. The chip or cartridge is provided with all of the reagents required to complete the immunoassay once the sample has been introduced. It can therefore be referred to as an integrated chip or integrated cartridge because no further reagents or wash fluid are required and then sample moves through the chip or cartridge without the need for external pumping.

The provision of a large number of samples, potentially in quite a small time window results in a need to store and sort the chips. In the above mentioned example, all employees may be requested to provide a sample on arrival at the workplace and therefore a large number of samples may be provided at a similar time.

Even though the reading part of the procedure is a relatively small amount of time, there remains a need to smooth the flow of chips in that an individual may have a number of chips in which the assays have been completed and may not wish to remain by the system in order to feed in each chip for reading sequentially. The user therefore needs to be able to present a number of chips all but simultaneously and the system needs to be able to accommodate these immediately and subsequently address the timing and reading of the assays.

The present invention will now be described, by way of example only, with reference to the accompanying figures in which:

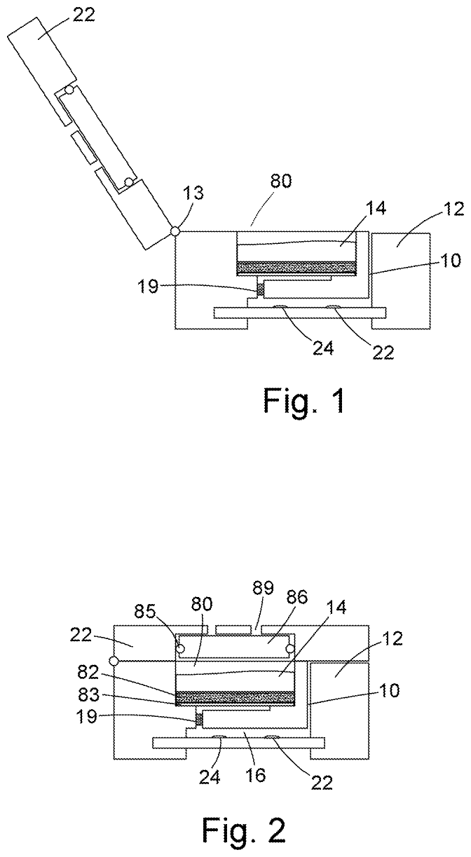

FIG. 1 shows schematically part of an assay chip during provision of a saliva sample;

FIG. 2 shows the assay chip in a closed position;

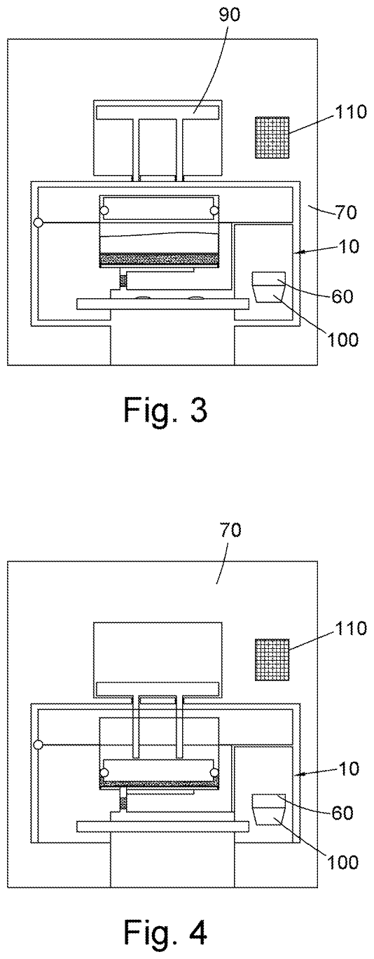

FIG. 3 shows the assay chip inserted in a reader;

FIG. 4 shows the assay chip actuated and the assay initiated;

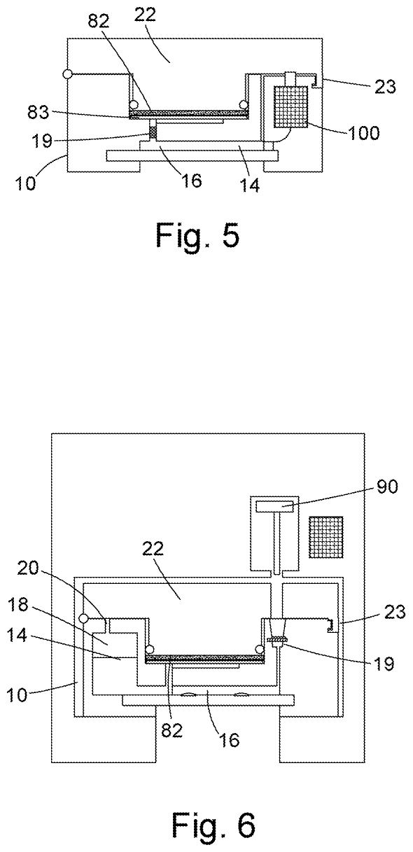

FIG. 5 shows an alternative assay chip;

FIG. 6 shows a further alternative assay chip;

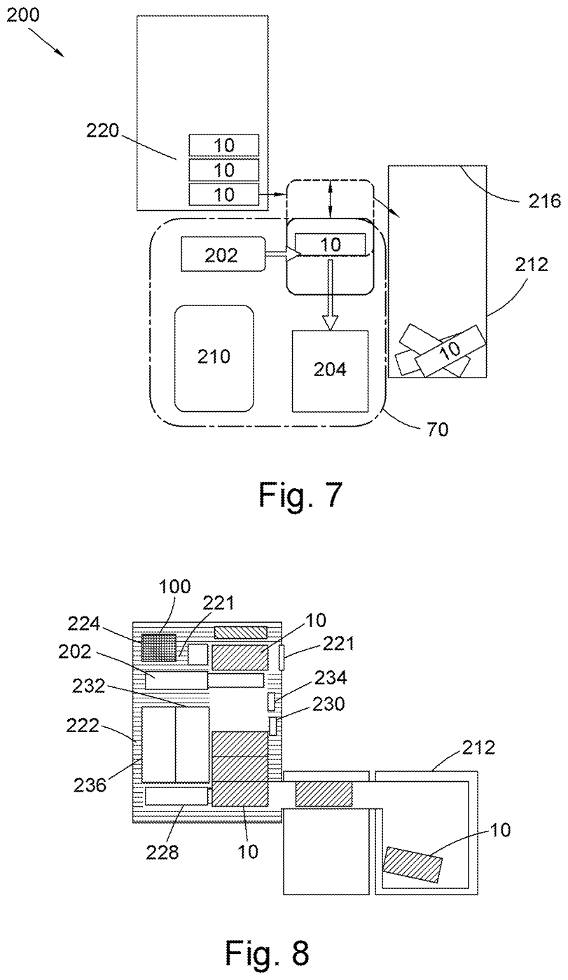

FIG. 7 shows a system for chip management;

FIG. 8 shows an example of a stacker that may form part of the chip management system of FIG. 7;

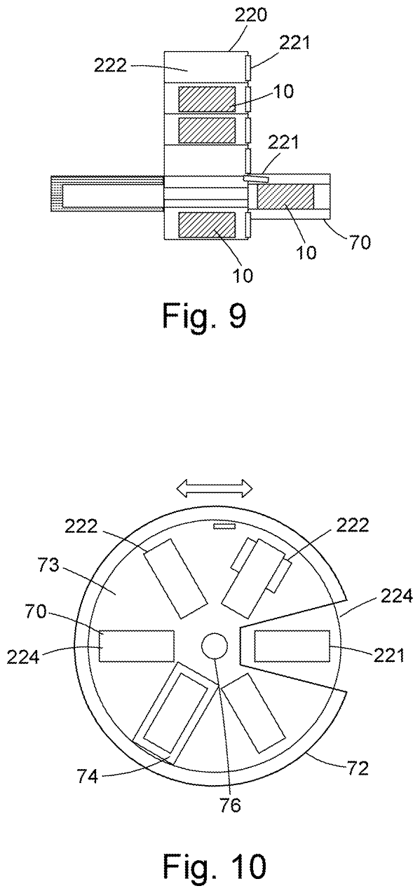

FIG. 9; shows an alternative example of a stacker that may form part of the chip management system of FIG. 7;

FIG. 10 shows an alternative system for chip management;

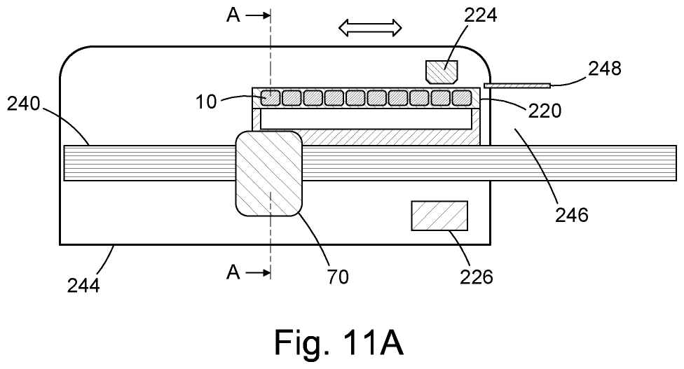

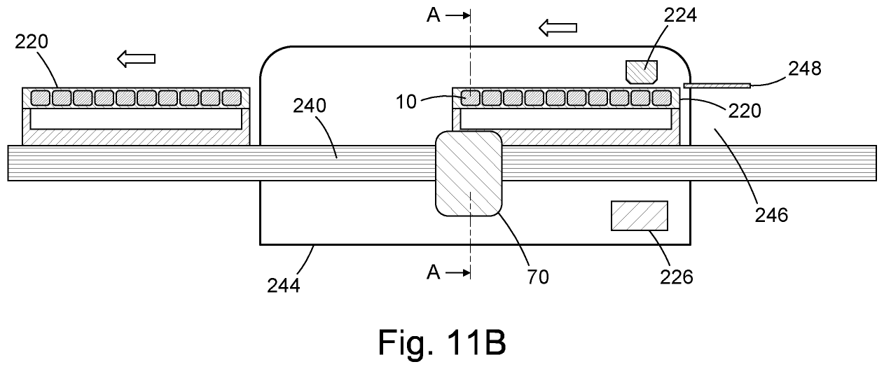

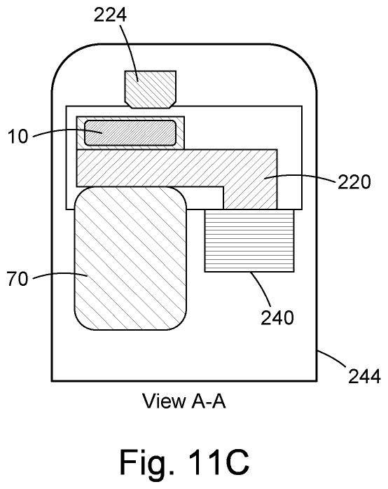

FIG. 11A shows a further alternative system for chip management;

FIG. 11B shows an alternative embodiment of the system for chip management; and

FIG. 11C shows a cross-section view of the system for chip management.

FIG. 1 shows an assay chip 10, including a sample reception device 12 for receiving a liquid sample 14. The sample reception device 12 includes an opening 80 into which the liquid sample 14 is introduced. Including a sample reception device 12 within the assay chip 10 facilitates the input of a liquid sample 14 directly from the user providing an integrated chip. The sample reception device 12 also includes a lid 22 configured to cover the opening 80 once a liquid sample 14 has been provided. The lid 22 prevents the liquid sample 14 from exiting the chip 10. The lid 22 is attached to the assay chip 10 by a hinge 13. A hinged configuration is advantageous in that the lid 22 cannot be separated from the assay chip 10 and lost by the user.

The sample reception device 12 is provided with a flow pathway 16 that links the opening 80 to the location of the detection reagents 24 and capture components 22. The detection reagents 24 and capture components 22 are provided within the chip, facilitating an integrated assay chip 10. The fluid pathway 16 is provided with a flow controller or flow restrictor 19 that prevents the liquid sample 14 from moving along the fluid pathway 16. The flow restrictor 19 may be a hydrophobic filter or a capillary stop.

The detection reagent binds to the target component to form a detection reagent-target component complex. This complex then binds to the capture component to form a sandwich assay. The detection reagent can have inherent light emitting or scattering properties or the detection reagent may have applied to it a label. The detection reagent may be an antibody or an antibody fragment, protein or a peptide, or a nucleic acid.

The label may be one or more of the following: a luminescent entity; a fluorescent entity; a phosphorescent entity; a chemiluminescent entity; an entity that exhibits scattering, such as Rayleigh, Raman or Mie scattering; an entity that exhibits photon upconversion; an enzyme and its substrate that together produce an optical signal such as a luminescent signal and any entity providing a colorimetric signal regardless as to process but specifically exemplified by change to absorption cross section or extinction. In this context, the term upconversion is used to denote any emission following a multi-photon excitation process and this includes two photon fluorescence particles.

In this context, the term entity is used to refer to one or more of the following: a molecule; a cell or cell fragment such as a fragment of cell membrane; an ion; a particle which may be metallic, organic, inorganic or polymeric; a nanoparticle; a cluster, or a quantum dot.

In the illustrated embodiment, in addition to the flow restrictor 19 there is a sponge 82 and or a filter 83 provided in the opening 80 where the liquid sample 14 is collected. In some embodiments, the functionality of these three items may be provided by one or two layers, for example a PTFE layer which may provide some filtering as well as restricting the flow of the sample. In embodiments such as that shown in FIG. 1 where it is provided as a separate item, the sponge 82 helps to locate the sample 14 and also provides a coarse grade filter to remove any unwanted particulate matter from the liquid sample 14. The filter 83 is downstream of the sponge 82 and filters out finer unwanted particulates from the sample.

As shown in FIG. 2, the lid 22 is moved to a closed position by the user. This ensures that the liquid sample 14 cannot leave the assay chip 10. The lid 22 does not necessarily provide an air tight seal, but it does provide sufficient barrier to exit that, in combination with surface tension, the lid 22 prevents at least majority of the liquid sample 14 from leaking out of the assay chip 10.

Located within the lid 22 is a plunger 86 which is held in place in a recess in the lid 22 by an O-ring 85. The plunger 86 is accessible via one or more through holes 89 adjacent to the plunger 86. There may be a single, annular through hole 89 or there may be a plurality of individual through holes 89 provided.

FIG. 3 shows the assay chip 10 inserted into a reader 70. The reader 70 is provided with a key 90 which is configured to match the through holes 89. Once the assay chip 10 has been inserted into the reader 70, the assay is commenced by the deployment of the key 90 initiating the plunger 86 via the through hole or through holes 89.

A controller 100 is provided to initiate a reaction timer 110 when the fluid sample 14 and the reagent 24 are brought into contact. The reaction timer 110 is provided in the reader 70 as the reader 70 will monitor the timing of the assay from the initiation of the assay, through the timing of the incubation phase and then identifying the correct time to take the reading of the results.

The controller 100 is provided as part of the sample management module that forms part of the assay chip 10. The controller 100 provides feedback to the reader that the key has effectively actuated the plunger to commence the assay and therefore the reaction timer, located on the reader 70 should be started.

The controller 100 also includes a unique identifier 60, the content of which can also be communicated to the reader 70. The unique identifier 60 may be passive, such as a QR code or barcode. If the unique identifier 60 is passive, then it can only be read and not written to. It is unique and has, as its primary purpose, to identify the specific assay chip on which it is provided. The identity may be made up of multiple pieces of information including the biomarkers provided as detection reagents and capture components and also the batch from which it is drawn. This information may be common to a number of chips. Within each batch, each chip then has a unique identifier 60 so that the results can be allocated to a specific user. The presence of a unique identifier 60 also provides an element of quality control because each assay chip can be identified and therefore it is possible to check whether a particular assay chip 10 has been tampered with or used incorrectly in any way.

In some embodiments, the unique identifier 60 is active and can be updated to include information about the progress of the assay. In embodiments in which the unique identifier 60 is editable, it will include some form of memory enabling a data storage facility. The data storage may be in any suitable form of memory, either volatile or non-volatile, including but not limited to RAM, SRAM, ROM, EEPROM or Flash memory. For example, the unique identifier may be an RFID tag.

FIG. 5 shows schematically a further embodiment of the chip 10 shown in FIGS. 1 and 2. There is a considerable commonality of components between the embodiments. The key difference between the embodiments is the functionality of the controller 100 and the location of the reaction timer 110. In this embodiment, the lid 22 is provided with a one way latch or clip 23 so that, once closed, it cannot be reopened without the application of disproportionate force and the plunger 86 is provided in a recess in the lid 22. The plunger 86 and sponge 82 are sized such that, when the lid 22 is closed the plunger 86 compresses the sponge 82 providing sufficient pressure to overcome the flow restrictor 19 and introduce the fluid sample 14 into the fluid pathway 16 in which the detection reagents 24 and capture components 22 are provided. In this way, the closure of the lid 22 by the user, commences the assay.

The reaction timer 110 is included on the assay chip 10 and the controller 100 includes a circuit that is completed by the closure of the lid which thereby commences the reaction timer 110. The data relating to the timing of the assay is stored in the controller 100 or on the unique identifier, if it is editable, for communication to the reader 70. In this embodiment, the assay chip 10 does not need to be introduced to the reader 70 until the assay has been completed.

The fluid pathway 16 can be provided with a sensor (not shown) that identifies when the sample fluid reaches the detection reagents 24. The sensor can be capacitive or conductive. In some embodiments, the closure of the lid and the commencement of the assay occur effectively at the same time. This is the case where the assay time is quite long, for example 8 hours or 12 hours and therefore the seconds or minutes that it takes for the liquid sample to come into contact with the detection reagents and thereby to commence the assay is a negligibly small percentage of the assay time. In some embodiments, although the time taken for the liquid sample to reach the detection reagents and therefore commence the assay is a statistically significant proportion of the assay time, it is a known quantity which is reasonably repeatable between assays. In those embodiments where neither of the above applies, then the provision of an additional sensor in the fluid pathway provides additional certainty as to the exact timing of the commencement of the assay.

FIG. 6 shows a further embodiment of the assay chip 10 shown in FIGS. 1 and 2. Although there is a high degree of commonality of features between the embodiments of FIGS. 1, 2 and 6, the control of the initiation of the assay is different in the embodiment of FIG. 6. The flow controller 19 is a burstable layer such as a plastic film that, once burst allows a capillary channel to draw passively the fluid sample 14 past the detection reagents 24. The flow controller 19 is actuated by a key 90 which bursts the layer either through physical contact, such as the key 90 having a sharp protrusion or through the application of, for example, laser light.

This configuration allows the lid 22 to be closed and therefore the sample encapsulated from further contamination, but the assay not commenced. The chip 10 can therefore be stored in this configuration with the liquid sample 14 contained within the assay chip 10 for the assay to be run at a later time. The actuation of the assay would therefore occur only when the key 90 was activated, either on introduction of the assay chip 10 into a storage and incubation device or reader.

Whilst the liquid sample 14 is held in the assay chip 10 prior to the bursting open of the flow controller 19 to enable the commencement of the assay, the fluid sample 14 is retained in a reservoir 18 and the pressure within the reservoir 18 is managed by the provision of a vent 20.

FIG. 7 shows a system 200 for chip management. The system 200 includes a reader 70 which comprises an illumination device such as a laser 202 and a detection device such as a camera 204. The laser 202 and the camera 204 are both directed to a berth or location at which an assay chip 10 is provided to be read. The reader 70 may be configured to take an optical measurement, such as light scattering or fluorescence measurement. The excitation light may be provided in the form of total internal reflection (TIR). There is also a controller 210 that communicates with a storage and incubation device 220. The system 200 also includes a waste chip bin 212.

The storage and incubation device 220 includes a plurality of berths 222 each sized to accommodate an assay chip 10; a scanner 224 configured to read the unique identifier 60 of each assay chip 10; a clock timer 226 configured to monitor the timing of the assay within each assay chip 10; and a completion module 228 to manage each assay chip 10 when the assay is complete.

The scanner 224 is provided for reader data from the unique identifier 60. The information includes, at a minimum, the identity of the assay chip and an indication as to the timing regimen in use. For example, the data provided with the unique identifier may identify the batch from which the assay chip has been drawn, together with a unique identifier for the single assay chip. The data can then include the fact that the timing cannot be carried out on the assay chip because the assay chip in question does not have a reaction timer. This information can then be processed within the storage and incubation device 200 to ensure that the clock timer 226 is timing the entire assay as there is no provision on the assay chip 10 to time the assay locally.

The clock timer 226 times the incubation of the assay on each assay chip 10 that is introduced into the storage and incubation device 220. Depending on the initiation of the assay, the clock timer 226 may time the entire assay from start to finish or it may align itself with a reaction timer provided on the assay chip 10. In the later circumstance, it will time only the later part of the assay, commencing its monitoring at the point where the assay chip is introduced into the storage and incubation device 220.

A processor 225 is provided to write data to the unique identifier tag 60 where appropriate. Where the unique identifier is an editable tag with a writable memory, the processor 225 provides information about the incubation and storage of the assay chip to the unique identifier 60. This can include, but is not limited to timing information and identity information about the storage and incubation device. This information may then be accessed by the reader 70 directly from the assay chip 10 when the reader 70 obtains the results of the assay. The data stored may be pre-processed by the processor 225 within the storage and incubation device 220 in order to minimise the number of write operations required and also to reduce or eliminate the processing required on the assay chip 10 itself which may have very limited computational or battery capability. Therefore, where possible, the processor 225 within the storage and incubation device 220 processes the data such that only a summary, or meta-data, is written to the assay chip 10.

FIG. 8 shows an example of the storage and incubation device 220. In this embodiment the berths 222 are located in a linear stack that is held by gravity so that each assay chip 10 falls down by gravity onto the completion module 228. The berths 222 comprise one or more features, such as slots or grooves to match the shape or configuration of the assay chip and therefore to aid alignment. Alternatively or additionally, the movement of the chips 10 within the storage and incubation device 220 may be managed by a spring force against a latch 223 that can release a chip 10 to be transferred to the reader 70. The completion module 228 of this embodiment of the storage and incubation device 220 is a linear actuator or conveyor which is configured to make a linear translation of the chip 10 so that it exits the storage and incubation device 220 and moves into the reader 70.

The storage and incubation device 220 includes a loading slot 221. The loading slot 221 guides the assay chip 10 into position on one of the berths 222 provided within the storage and incubation device 220. Each of the berths is sized to accommodate an assay chip 10. The loading slot 221 is sized to compress the assay chip 10 thereby forcing the latch 23 to close the lid 22 of the assay chip 10 and the commencement of the assay. This may be achieved by the loading slot 221 being only just sufficiently large to accommodate the assay chip 10 and thereby to provide pressure around the circumference of the assay chip 10. Alternatively, the loading slot can include a projection at a key point on the circumference of the loading slot such that pressure is applied to a key part of the assay chip, adjacent to the latch 23 on the lid 22 of the assay chip 10.

The storage and incubation device 220 also includes a temperature sensor 230 and temperature controller 232. The rate at which assays progress is dependent on the temperature at which they are incubated. Some assays have a wide operating envelope with regard to temperature. In these circumstances it may be sufficient to monitor the temperature. Information about the temperature may be logged in the memory 62 associated with the controller 100 of the assay chip 10. This data can be used to identify when the assay will be complete. For example, if the assay proceeds more rapidly at an elevated temperature, then the assay will have progressed sufficiently to take a reading at an earlier time than would be the case at a lower temperature.

If the assay has a more narrow operating envelope, then the temperature controller 232 is used to modulate the temperature to ensure that the temperature remains within the required operating envelope of the assay.

The temperature controller 232 can also be used in circumstances where the operating envelope is wider, but the unique identifier 60 is not editable. In these embodiments, the temperature data cannot easily be stored on the assay chip 10 and therefore the rate at which the assay progresses has to be more actively controlled to ensure that it progresses at a predetermined rate by raising or lowering the temperature to a predetermined level.

A humidity sensor 234 and humidity controller 236 are provided. As with temperature sensing and control as outlined above, some assays are fairly resilient as to the humidity and a monitoring approach may be sufficient. In circumstances where the assay is more sensitive to the humidity, the humidity controller can be activated to maintain the humidity within a tighter acceptable operating window.

The completion module 228 may transfer the assay chips 10 to the waste chip bin 212. The waste chip bin 212 is a collection location for used chips. Depending on the chip contents, the chips may be removed from this location and disposed of in household waste by the user. However, the chips may be recycled and therefore the user may be expected to send them back to the service provider where they may be recommissioned or recycled in whole or in part. Alternatively, the waste chip bin 212 may store the chips securely for disposal via biohazard waste removal preventing the user from contacting the used chips. In order to alert the user to the need to empty the waste chip bin 212, there is a sensor 214 and an alarm 216 to communicate to the user that the waste chip bin needs to be emptied.

The completion module 228 includes a moving plate 229 that acts as a transferring element, linear actuator or conveyor configured to move the assay chip 10 from the storage and incubation device 220 and into the reader 70.

Movement of the assay chip 10 from the reader 70 into the waste chip bin 212 can either occur on a continuation of the moving plate 229 or by pressure in that the introduction of a subsequent assay chip 10 into the reader 70 displaces the incumbent assay chip 10 and ejects it into the waste chip bin 212.

FIG. 9 shows an alternative embodiment of the storage and incubation device 220 that is provided with a plurality of loading slots 221. Each loading slot 221 is provided adjacent to a corresponding berth 222 onto which an assay chip 10 can be delivered. The entire storage and incubation device 220 is then configured to move relative to the reader 70 so that the outlet of the reader 70 can be positioned adjacent to any one of the loading slots 221. The storage and incubation device 220 is provided with a mechanism that ejects an assay chip 10 from one of the berths 222 through the loading slot and directly into the reader 70. In this configuration the loading slot 221 is also effectively an unloading slot as the assay chip 10 both arrives and leaves the storage and incubation device 220 through the same slot 221.

FIG. 10 shows an alternative configuration in which the storage and incubation device 220 and the reader 70 are accommodated within a single housing 72. The housing 72 is substantially cylindrical and the berths 222 are configured on a planar circular surface 73 that can rotate around the axis 76 of the cylinder. The rotation of the berths 222 is indexed so that the berths 222 can stop in one of a predetermined number of positions around the circle. Each predetermined location at which a berth can stop has a defined function. One of the locations includes the loading slot 221 which may be an indentation in the housing 72 configured to expose the berth 222 indexed to the loading location. One of the locations includes the reader 70 so that the results of the assay on the assay chip 10 can be read when the assay chip 10 is indexed to the reading position. One of the locations includes a waste shoot 74 from which assay chips 10 may be sent to the waste chip bin, not shown in this embodiment as it is located beneath the berths 222. All of the other locations are used for incubation.

Although a total of six locations are shown in FIG. 10, the device 220 can be configured with any number of locations as appropriate. There must be at least three locations: loading, reading and ejection to waste. The scanner 224 can be positioned to interrogate the assay chip 10 in the loading or reading location. In most examples there will be at least four locations so that there is at least one dedicated incubation location. There may be one, two, three, four, five, ten or up to twenty incubation locations, but accommodating many more makes the design cumbersome as the required diameter increases to accommodate all of the incubation locations.

FIG. 11A shows an alternative configuration in which the storage and incubation device 220 is configured to move back and forth along a track 240. The storage and incubation device 220 can move into and out of a housing 244 through an entry/exit point 246. The housing 244 comprises a reader 70; a communication module which is a scanner 224 configured to read the unique identifier of each assay chip 10; and a clock timer 226 configured to monitor the timing of the assay within each assay chip 10.

The entry/exit point 246 within the housing 244 facilitates the loading and unloading of the storage and incubation device 220 by the user or by an ancillary device such as a completion module. Assay chips 10 are loaded into a plurality of berths in the storage and incubation device 220 simultaneously, and the storage and incubation device 220 is then moved along the track 240 into the housing 244 via the entry/exit point 246. The entry/exit point 246 in the housing 244 is provided with a cover 248 to prevent dirt, dust and light from entering the housing 244. In the illustrated embodiment, the assay chips 10 are held within the berths of the storage and incubation device 220 by gravity. In alternative embodiments, not illustrated, the assay chips 10 can be retained by a latch or clip.

The movement of the storage and incubation device 220 along the track 240 brings each assay chip 10 past a scanner 224 within the housing 244. The scanner 224 is configured to read the data from the unique identifier of each assay chip 10 which can provide, inter alia, an indication as to the timing regimen for each assay chip 10. The incubation of the assay on each assay chip 10 can be addressed accordingly and the order in which the assay chips 10 are entered into the reader 70 can be adjusted as required.

The storage and incubation device 220 is moved back and forth along the track 240, to align a berth of the storage and incubation device 220 with the reader 70 when it is determined that a reading is required to be taken from a particular assay chip 10. Each assay chip 10 can be read by the reader 70 as many times as is required thereby enabling sequential reads from the same chip and providing multiple different time points during the assays.

In the embodiment shown in FIG. 11A, the reader 70 is an integral part of the device. However, alternatively, the reader 70 may be located outside of the housing 244, in which case the alignment of the reader 70 must be known and either calibrated during assembly of the device or actively read during reading. This ensures correct alignment of the berths of the storage and incubation device 220 with respect to the reader 70.

When the assays are determined to be complete, the completion module moves the storage and incubation device 220 out of the housing 244 via the entry/exit point 246, and to an accessible position for attention of the user. The completion module can also be configured to alert the user that the assay is complete through an audible or visual alert, or by notification via SMS, phone alert or e-mail. It is also possible that the notification can be sent in conjunction with a result.

FIG. 11B shows a similar embodiment to FIG. 11A, with multiple storage and incubation devices 220 on the same track 240, each configured to move in one direction only. In this embodiment, assay chips 10 are loaded into the berths of multiple storage and incubation devices 220 simultaneously, enabling a greater number of assay chips 10 to be loaded into the system at once than in the embodiment shown FIG. 11A. In some configuration, not illustrated, multiple readers 70 can be located at different points along the track 240, so that each reader 70 can take a reading from an assay chip 10 as required, and sequential readings can be taken by sequential readers 70.

Each reader 70 is in communication with the others, either directly or via a central location such as the cloud, where the readings are aggregated, and the unique identity data of each assay chip 10 is used to assign each new reading to the intended user and add it to that user's data.

The track 240 may form a complete loop circuit, or can return the storage and incubation devices 220 to the start point via another track 240, enabling the storage and incubation devices 220 to be continuously re-used.

The completion module can be configured to load and remove assay chips 10 from the berths of the storage and incubation device 220 automatically after the desired number of readings have been taken or a predetermined time has elapsed.

FIG. 11C shows a cross section view of the device of FIGS. 11A and 11B, and shows how the storage and incubation device 220 can be configured to position the assay chips 10 adjacent to the track 240. Alternatively, the track 240 can be mounted in different orientations.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1. A storage and incubation device configured to accommodate a plurality of assay chips, each assay chip including an identifier, the device comprising:
a plurality of berths each sized to accommodate an assay chip;
a communication module configured to receive information about the identifier of each assay chip;
a clock timer configured to monitor the timing of the assay within each assay chip;
a completion module to manage each assay chip when the assay is complete.

2. The device according to claim 1, wherein the completion module includes a mechanism to eject the assay chip from the device.

3. The device according to claim 1 or claim 2, wherein the communication module is further configured to obtain clock data from the assay chip and provide this clock data to the clock timer.

4. The device according to any one of claims 1 to 3, further comprising a loading slot sized to accommodate an assay chip.

5. The device according to claim 4, wherein the loading slot is provided with a cover.

6. The device according to any one of claims 1 to 5, further comprising at least one sensor for monitoring the conditions within the device.

7. The device according to claim 6, wherein the sensor is a temperature sensor.

8. The device according to claim 6, wherein the sensor is a humidity sensor.

9. The device according to any claim 6 or claim 7, further comprising a temperature control device.

10. The device according to claim 8, further comprising humidity control device.

11. The device according to any one of claims 1 to 10, further comprising a protrusion that mechanically urges the chip into a configuration whereby the assay is initiated.

12. The device according to any one of claims 1 to 11, further comprising a mechanism for reordering the assay chips.

13. The device according to any one of claims 1 to 12, wherein the assay chip is an integrated assay chip.

14. A system for managing incubation and reading of assay chips, the system comprising a storage and incubation device according to any one of claims 1 to 12 and a reader.

15. The system according to claim 14, wherein the system is configured to take multiple readings from each chip.

16. The system according to claim 14, wherein the reader is provided in a light tight case.

17. The system according to claim 14 or claim 16, wherein the reader includes a communication module that enables transfer of data from the storage and incubation device.

18. The system according to any one of claims 14 to 17, further comprising a used chip collection zone.

19. The system according to claim 18, wherein the used chip collection zone has a sensor to indicate that it needs to be emptied.

20. The system according to any one of claims 14 to 19, wherein the storage and incubation device and the reader are contained within a common housing.
